(19) United States
(12) Patent Application Publication
(10) Pub. No.: US 2013/0227972 A1
(43) Pub. Date: Sep. 5, 2013

(54) PATTERNED SUPERHYDROPHOBIC SURFACES TO REDUCE ICE FORMATION, ADHESION, AND ACCRETION

(71) Applicants: Benjamin Hatton, Cambridge, MA (US); Lidiya Mishchenko, Cambridge, MA (US); Joanna Aizenberg, Cambridge, MA (US); Tom Krupenkin, Madison, WI (US); Joseph Ashley Taylor, Madison, WI (US)

(72) Inventors: Benjamin Hatton, Cambridge, MA (US); Lidiya Mishchenko, Cambridge, MA (US); Joanna Aizenberg, Cambridge, MA (US); Tom Krupenkin, Madison, WI (US); Joseph Ashley Taylor, Madison, WI (US)

(73) Assignees: Wisconsin Alumni Research Foundation, Madison, WI (US); President and Fellows of Harvard College, Cambridge, MA (US)

(21) Appl. No.: 13/575,873

(22) PCT Filed: Jan. 28, 2011
(86) PCT No.: PCT/US2011/022878

§ 371 Date: May 22, 2013

Related U.S. Application Data
(60) Provisional application No. 61/299,214, filed on Jan. 28, 2010.

(51) Int. Cl. B08B 17/06

(52) U.S. Cl. CPC B08B 17/065
USPC 62/71; 428/156; 428/167; 62/66

(57) ABSTRACT

A method for reducing ice formation. The method involves using a substrate that has a patterned hydrophobic surface including raised structures. Also disclosed is a substrate having a hydrophobic surface including raised structures that form compartments or grooves having a surface free of angles that are less than or equal to 90°.

### RELATED APPLICATIONS

This PCT application claims the benefit of the Jan. 28, 2010 priority date of U.S. Provisional application 61/299,214, the contents of which are herein incorporated by reference.

### GOVERNMENT SUPPORT

This invention was made with government support under HR0011-08-C-0114 awarded by the United States Department of Defense. The government has certain rights in the invention.

### BACKGROUND

Ice adhesion and accretion can cause serious problems. Examples include vehicle/aircraft accidents, rooftop collapses, and power outages.

Most de-icing and anti-icing methods require use of applied power, an anti-icing agent, or both, and can be cost ineffective when applied to a large area. An alternative approach resorts to ice-release and self-de-icing coatings, e.g., coatings impregnated with grease, a release agent, or a freezing-point depressant. However, these coatings have a limited service-life as the impregnated chemical leaks out over time.

There is a need for improved anti-icing and de-icing methods.

### SUMMARY

This invention is based on an unexpected discovery that certain patterned hydrophobic surfaces can be used to repel water droplets contacting a substrate, thereby reducing the contact time for ice nucleation and the adhesion of ice. Thus, the overall accretion of ice formed from water droplets is reduced.

In one aspect, this invention relates to a method for preventing or reducing ice formation on a substrate.

To practice this method, a substrate having a hydrophobic surface that includes raised structures is subjected to conditions allowing ice formation. Each of the raised structures has a height of 0.1 μm to 1000 μm (preferably 1 μm to 50 μm and most preferably 2 μm to 10 μm) and a thickness of 0.01 μm to 1000 μm (preferably 0.1 μm to 50 μm and most preferably 0.5 μm to 10 μm), and the distance between two adjacent raised structures is 0.02 μm to 1000 μm (preferably 0.5 μm to 100 μm and most preferably 1 μm to 50 μm).

The term “hydrophobic surface” refers to a surface on which a water droplet displays a contact angle of more than 90°. The term “height” refers to the distance between the distal-most point of a raised structure and its normal projection on the basal plane of that raised structure, wherein the basal plane is the plane connecting three non-aligned points of lowest altitudes surrounding the raised structure. Put differently, the normal projection of the distal-most point on the basal plane is the point that is the least distant from the distal-most point. The term “thickness” refers to the thickness at the distal end of a raised structure. The term “conditions allowing ice formation” refers to temperatures and pressures at which liquid water becomes ice, e.g., −10° C. and standard atmospheric pressure. In one example, the substrate, at a temperature≦0° C. and at standard atmospheric pressure, is subjected to supercooled water droplets, i.e., water droplets cooled to a temperature below their freezing point without becoming solid.

The raised structures can be of various shapes and dimensions (e.g., height and thickness). They can also be either isolated or interconnected. Thus, different surface patterns, including periodic patterns, can be formed of raised structures having different dimensions, shapes, and spatial arrangements.

In one embodiment, the raised structures are isolated posts having a diameter at their distal end of 0.01 μm to 100 μm (preferably 0.05 μm to 25 μm and most preferably 0.2 μm to 5 μm), a height of 0.1 μm to 1000 μm (preferably 1 μm to 100 μm and most preferably 5 μm to 25 μm), and a pitch, i.e., distance between the centers of two adjacent posts at their distal end, of 0.05 μm to 200 μm (preferably 0.1 μm to 50 μm and most preferably 0.5 μm to 10 μm). The diameter of a post can be constant along its height or change. Thus, the profile of a post can be either columnar, conical, pyramidal, prismatic or curvy. The posts can be oriented perpendicular or oblique to the substrate. The dimensions, shape, and spatial arrangement of isolated posts on a substrate can vary. For example, the isolated posts can be symmetrically arranged or randomly positioned.

In another embodiment, isolated raised structures lead to a surface having grooves, which can be sinuous. The term “groove” refers to a channel that is delimited by a bottom surface and two raised structures, e.g., two non-intersecting walls. The grooves can be flat-bottomed or have a surface free of angles that are less than or equal to 90°. For example, they can be round-bottomed. The walls can be oriented straight or oblique to the substrate. The raised structures in this embodiment typically have a height of 0.1 μm to 1000 μm (preferably 1 μm to 100 μm and most preferably 2 μm to 20 μm), a thickness of 0.01 μm to 1000 μm (preferably 0.1 μm to 50 μm and most preferably 0.5 μm to 10 μm), and the distance between two adjacent structures can be 0.02 μm to 1000 μm (preferably 0.25 μm to 100 μm and most preferably 1 μm to 25 μm).

Alternatively, the raised structures are interconnected walls that form compartments, i.e., cavities each delimited by a bottom surface and one or more straight or oblique walls. These compartments can be regularly or irregularly shaped. They can also be flat-bottomed or have a surface free of angles that are less than or equal to 90° (e.g., round-bottomed).

Based on the number of interconnected raised structures and the angle between two consecutive raised structures, compartments of different geometries can be formed. Examples of such compartments include, but are not limited to, square compartments (i.e. delimited by four identical walls), rectangular compartments (i.e., delimited by four walls and each two opposite walls are identical), triangular compartments (i.e., delimited by three walls), hexagonal compartments (i.e., delimited by six walls), circular or elliptical compartments (i.e., delimited by one wall), randomly-shaped compartments, and a combination thereof.

The dimensions (e.g., length and width) of a compartment can vary. For example, a compartment that is delimited by walls having a height of 0.1 μm to 1000 μm (preferably 1 μm to 100 μm and most preferably 2 μm to 20 μm) can have a length of 0.02 μm to 1000 μm (preferably 0.25 μm to 200 μm and most preferably 1 μm to 50 μm) and a width of 0.02 μm to 1000 μm (preferably 0.25 μm to 200 μm and most preferably 1 μm to 50 μm).

The compartments can be arranged in rows. Such an arrangement forms when rows of longitudinal walls intersect with transverse walls. Compartments in two adjacent and parallel rows can be staggered.

Note that the dimensions of a raised structure, i.e., its height, thickness, and distance to an adjacent raised structure, are not a combination of any value included in the above ranges. Indeed, to determine the dimensions of a raised structure, one has to consider several factors, e.g., the type of application (e.g., preventing formation of ice from supercooled water droplets on a rooftop or aircraft), the size of a water droplet, and the velocity of a water droplet (which is either already present before ice forming conditions develop or impinges on the substrate under ice forming conditions). For more details, see the discussion set forth below.

The method of this invention can also include a step of confirming that the hydrophobic surface is substantially free of ice, i.e., no continuous layer of ice is formed and the surface preserves its ice-repelling capabilities. It can further include a step of removing any ice formed on the hydrophobic surface of the substrate.

In another aspect, this method relates to a unique substrate having a hydrophobic surface that includes compartments formed by raised structures and having a surface free of angles that are less than or equal to 90°. Each of the raised structures has a thickness at the distal end of 0.01 μm to 1000 μm (preferably 0.1 μm to 50 μm, and most preferably 0.5 μm to 10 μm) and a height of 0.1 μm to 1000 μm (preferably 1 μm to 100 μm and most preferably 2 μm to 20 μm), and the dimensions of the compartments are as follows: a length at the distal end being 0.02 μm to 1000 μm (preferably 0.25 μm to 200 μm and most preferably 1 μm to 50 μm) and a width at the distal end being 0.02 μm to 1000 μm (preferably 0.25 μm to 200 μm and most preferably 1 μm to 50 μm. The pattern formed by the raised structures and the compartments may vary based on the spatial arrangement of the raised structures (i.e., walls). For example, parallel longitudinal walls intersecting with transverse (e.g., perpendicular) walls form rows of parallel compartments, which can be staggered. In one embodiment, the compartments are round-bottomed.

In a further aspect, this invention relates to another unique substrate having a hydrophobic surface that includes grooves formed by raised structures and having a surface free of angles that are less than or equal to 90°. Each of the raised structures has a thickness at the distal end of 0.01 μm to 1000 μm (preferably 0.1 μm to 50 μm and most preferably 0.5 μm to 10 μm) and a height at the distal end of 0.1 μm to 1000 μm (preferably 1 μm to 100 μm and most preferably 2 μm to 20 μm); and the distance between two adjacent structures is 0.02 μm to 1000 μm (preferably 0.25 μm to 100 μm and most preferably 1 μm to 25 μm). In one embodiment, the grooves are round-bottomed. In another embodiment, the surface pattern is a round-bottomed blade array.

The details of one or more embodiments of the invention are set forth in the description below. Other features, objects, and advantages of the invention will be apparent from the description and from the claims.

### BRIEF DESCRIPTION OF DRAWINGS

FIG. 1 is a schematic representing top views of different surface patterns formed by isolated posts.

FIG. 2 is a schematic representing top views of different surface patterns in which non-intersecting walls define grooves.

FIG. 3 is a schematic representing top views of different surface patterns in which intersecting walls define compartments.

FIG. 4 is a schematic of a perspective view of an ordered post array.

FIG. 5 is a schematic of a perspective view of an ordered blade array.

FIG. 6 is a schematic of a perspective view of an ordered brick array.

FIG. 7 is a schematic representing cross-sectional views of five different arrays featuring compartments or grooves having a surface free of angles that are less than or equal to 90°.

### DETAILED DESCRIPTION

Within the scope of the present invention is a method for reducing ice formation on a substrate by providing the substrate with a hydrophobic surface that includes raised structures arranged to form a pattern, i.e., a pre-determined design.

The method of this invention can be utilized for various applications in which it is important to avoid ice accretion on a substrate. For example, it is important to avoid ice formation on the surfaces of an aircraft (e.g., wings) before takeoff and during flight. Currently, heating coils or mechanical (e.g., inflatable shell) methods are used to remove ice on aircraft wings during flight. An advantage of the method of this invention is that it provides a more energy-efficient and versatile way to remove ice on aircraft surfaces as less or no ice needs to be removed and its attachment to the surface is significantly reduced. The method of this invention can also be used to reduce or prevent ice formation, adhesion, and accretion on, among others, rooftops, antennas, roads, road signs, solar panels, pipes and power lines.

The raised structures, which can be of various shapes, are typically on the order of nanometers or micrometers in at least one dimension. For example, they can be posts having a diameter at their distal end of 0.05 μm to 5 μm and walls having a thickness at their distal end of 0.1 μm to 5 μm.

Different surface patterns, including periodic patterns, can be formed of raised structures having different shapes, different dimensions (e.g., width and length), and different spatial arrangements.

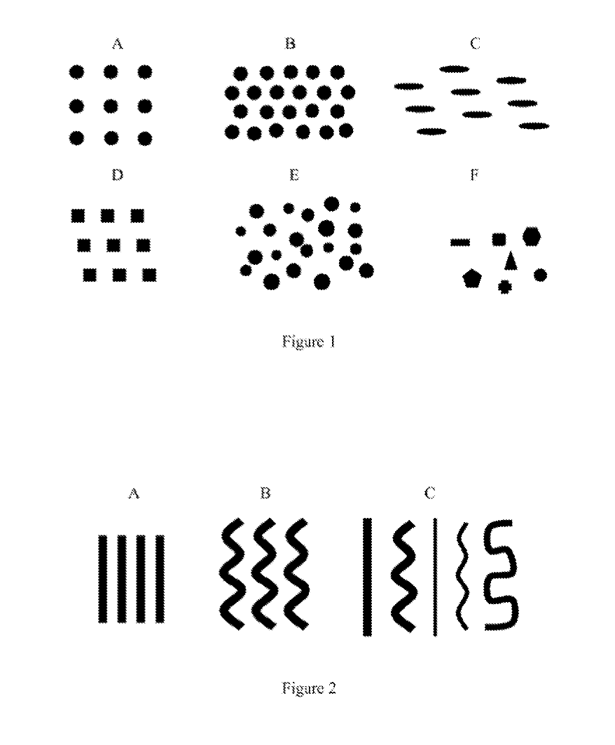

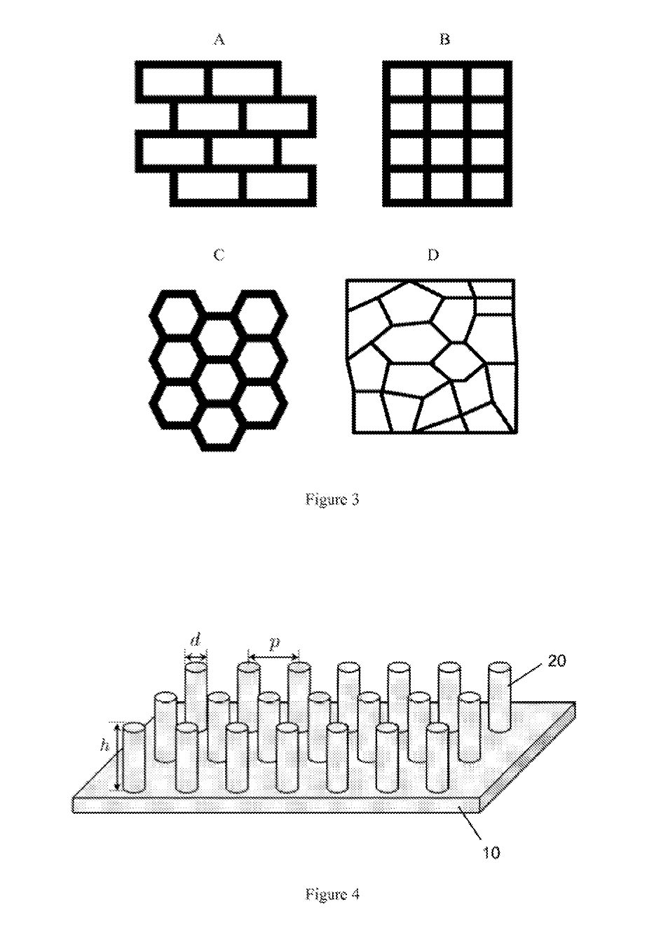

A periodic pattern is an ordered arrangement of repeating units. For example, referring to FIGS. 1A-1D, a periodic pattern can be an ordered array of regularly positioned isolated posts having the same diameter and the same pitch. Other examples of periodic surface patterns include ordered blade arrays (as shown in FIG. 2A), ordered sinuous groove arrays (as shown in FIG. 2B), ordered brick arrays (as shown in FIG. 3A), ordered box arrays (as shown in FIG. 3B), and ordered honeycomb arrays (as shown in FIG. 3C).

FIG. 4 represents a schematic of a perspective view of an ordered post array, in which isolated posts 20 on a substrate 10 have a diameter d of 0.01 μm to 100 μm at their distal end, a height h of 0.01 μm to 1000 μm, and a pitch p of 0.05 μm to 200 μm. A top view of an ordered post array is shown in FIG. 1A.

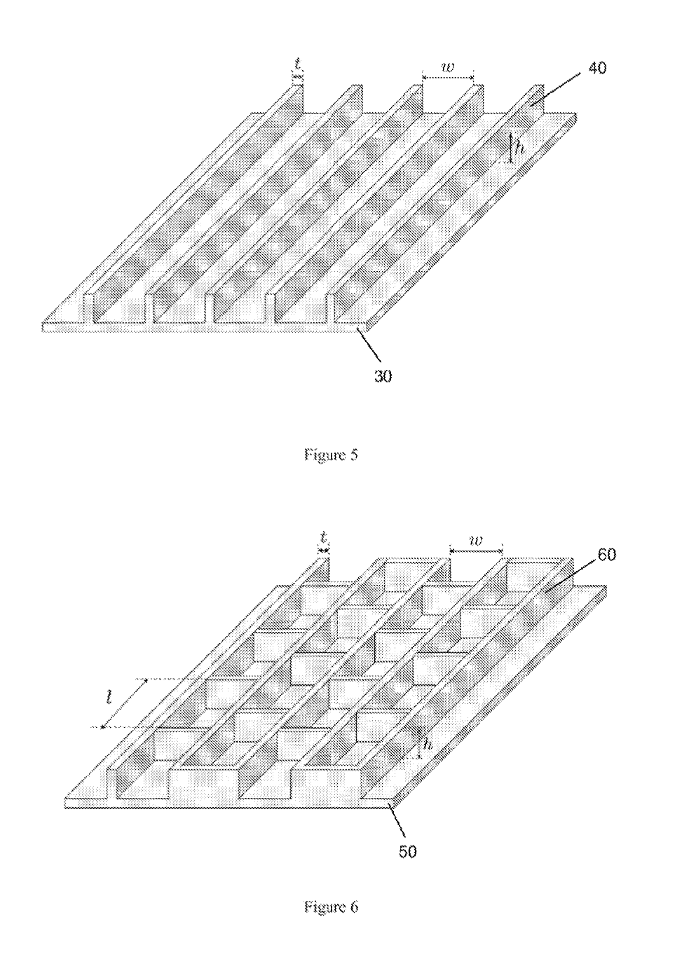

FIG. 5 represents a perspective view of a blade array in which a succession of straight, non-intersecting walls 40 defines a succession of straight grooves. FIG. 2A represents a top view of a blade array. FIG. 2B represents a variation in which sinuous grooves are defined by sinuous, non-intersecting walls.

A brick array, a box array, and a honeycomb array are all formed of walls as raised structures, having a preferred thickness of 0.5 μm to 10 μm and a height of 2 μm to 20 μm, that intersect to form compartments. As shown in FIG. 6, in a brick array, the walls 60 of a thickness t and a height h define rectangular staggered compartments that can be of a length l of 1 μm to 50 μm and a width w of 1 μm to 25 μm. FIG. 3A represents a top view of a brick array. As shown in FIG. 3B, in a box array, walls define rectangular compartments arranged in a grid-like pattern, each having a length of 1 μm to 50 μm, a width of 1 μm to 25 μm, and a depth of 2 μm to 20 μm. As shown in FIG. 3C, in a honeycomb array, walls define hexagonal compartments arranged in a honeycomb pattern.

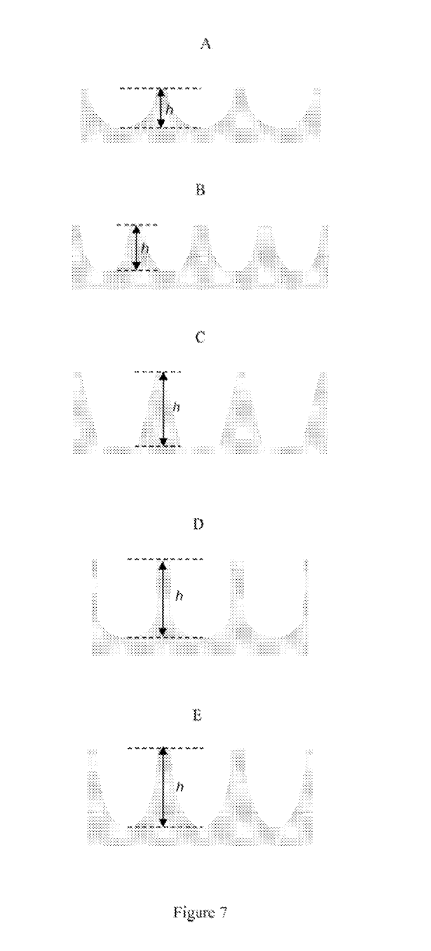

Grooves can be of various shapes. For example, a groove can be a rectangular parallelepiped (as shown in FIG. 5), a hemi-cylinder (as shown in FIG. 7A), a complete rectangular pyramid, a truncated rectangular pyramid, or a combination of two rectangular pyramids (as shown in FIG. 7B). In sum, a groove can be flat-bottomed (again, as shown in FIG. 5) or have a surface free of angles that are less than or equal to 90° (as shown in FIGS. 7A-7E). Analogously, a compartment can have a variety of shapes. For example, it can have a shape of a prism (e.g., a rectangular cuboid, as shown in FIG. 6), a cylinder, a complete pyramid, a truncated pyramid (as shown in FIG. 7C), a trapezoidal pyramid, a complete cone, or a truncated cone. It can be flat-bottomed (again, as shown in FIG. 6) or have a surface free of angles that are less than or equal to 90° (as shown in FIGS. 7A-7E). Both compartments and grooves can be round-bottomed, i.e, having a bottom in the form of a truncated sphere (as shown in FIGS. 7A and 7D) or of a truncated ellipsoid (as shown in FIG. 7E).

Referring back to FIGS. 7A-7E, FIG. 7A represents a cross-sectional view of an array featuring round-bottomed grooves or compartments having a shape of a hemisphere, which are defined by walls having a height h; FIG. 7B represents a cross-sectional view of an alternative array featuring grooves or compartments having a complex shape of superimposed truncated pyramids, which are defined by walls having a height h; FIG. 7C represents a cross-sectional view of an array featuring grooves or compartments having a shape of a truncated pyramid, which are defined by walls having a height h; FIG. 7D represents a cross-sectional view of an array featuring round-bottomed grooves or compartments having a combined shape of a cylinder and a hemisphere, which are defined by walls having a height h; and FIG. 7E represents a cross-sectional view of an array featuring round-bottomed grooves or compartments having a shape of a hemi-ellipsoid, which are defined by walls having a height h.

Alternatively, random patterns can also be defined by raised structures. For example, referring to FIGS. 1E and 1F, posts of different sizes and/or shapes can be randomly positioned on the substrate surface to form a random post array. FIG. 2C depicts a random pattern formed by a non-repetitive succession of non-intersecting walls of different thicknesses and shapes. As shown in FIG. 3D, a random pattern can also be defined by walls that intersect to form compartments of various shapes and sizes.

A substrate for use in this invention can have one or more of the above-described surface patterns.

One can determine the type of surface pattern, the dimensions of a raised structure, the distance between two adjacent raised structures based on several factors, e.g., substrate temperature, water droplet temperature, water droplet size, and water droplet velocity (i.e., static or impinging). Under dynamic conditions, it is preferable to use a patterned surface displaying better mechanical robustness and droplet pressure stability. For example, a closed-cell surface pattern (e.g., a brick array) is preferred over an open-cell surface pattern (e.g., a post array). Indeed, a surface having a closed-cell pattern, especially one having round-bottomed compartments, displays better performance in terms of mechanical stability, pressure stability, and/or superhydrophobicity/wetting transition than a surface having an open-cell pattern for a same size range. Note that the droplet pressure stability is related to the maximum pressure a droplet can exert on a patterned surface without transitioning to the wetted state.

It is important that the contact area and/or the contact time between the water droplet and the substrate surface be limited to minimize heat transfer and the number of nucleation sites at the interface and thus reduce the possibility that the water droplet freezes or crystallizes on the surface.

To minimize the contact area between a water droplet and a patterned hydrophobic surface, one has to maximize the possibility that the droplet remains in the so-called Cassie-Baxter state, i.e., non-wetted state, without transitioning to the so-called Wenzel state, i.e., wetted state. Note that a droplet in the Cassie-Baxter state only wets the tops of raised structures, thereby minimizing the contact area. In contrast, a droplet in the Wenzel state wets the entire surface. For a discussion of these two states, see, e.g., Cassie et al., Trans. Faraday Soc., 1944, 40, 546-550 and Wenzel, J. Phys. Colloid Chem., 1949, 53, 1466-1467. To maximize the possibility that a droplet stays in the Cassie-Baxter state, one can decrease the size of raised structures of appropriate dimensions on a hydrophobic surface, thereby further increasing the hydrophobicity of the surface. Indeed, this approach allows one to prepare a superhydrophobic surface, i.e., a surface on which a water droplet has a contact angle equal to or greater than 140°. Note that the larger the contact angle is, the smaller the contact area is. A substrate having a superhydrophobic surface is preferred, as it is important to limit the contact area between a water droplet and a substrate surface in the method of this invention. This limited area of contact is shown to be maintained even upon freezing of static and impacting droplets on superhydrophobic surfaces, allowing for ease of ice removal as compared to unpatterned surfaces.

Also, since there exists an induction time for crystallization (i.e., the time required for a liquid in contact with a substrate to crystallize), one can create conditions for which water droplets bounce off a surface before crystallization occurs. Supercooled water droplets bounce off a patterned superhydrophobic surface and their contact time with the surface is shorter than the time required for crystallization. In contrast, supercooled droplets typically neither bounce off unpatterned hydrophobic surfaces, nor patterned or unpatterned hydrophilic surfaces. As a result, such droplets can remain in contact with these surfaces and freeze to form an accumulating ice layer. In general, the dimensions of a grooved structure (i.e., the distance between walls) or of a closed-cell structure (i.e., the length and width of a compartment) should be three times (preferably ten times) smaller than the typical droplet size. Droplet sizes and velocities can be determined by means well known in the field. For example, these values can be found in the FAA Federal Aviation Regulations (FAR) Appendix C, which presents these values for various atmospheric conditions (temperature, altitude, droplet size, liquid water content) based on the altitude, icing duration, and aircraft speed.

The patterned surfaces for use in this invention can be formed of various materials including, but not limited to, silicon, sapphire, metals (e.g., aluminum or chromium), inorganic glasses (e.g., silica, alumina or titania), and organic polymers (e.g., epoxy, teflon, polyolefins, acrylics, or PVC).

To fabricate the patterned surfaces, one can use standard methods known in the art, such as photolithography, soft lithography, and projection lithography. For example, a silicon substrate having a post array, a brick array, a blade array, a box array, or a honeycomb array can be fabricated by photolithography using the Bosch reactive ion etching method (as described in Plasma Etching: Fundamentals and Applications, M. Sugawara, et. al, Oxford University Press, (1998), ISBN-10: 019856287X).

Patterned surfaces (e.g., a brick array) can also be obtained as replicas (e.g., epoxy replicas) by a soft lithographic method (see, e.g., Pokroy et al., Advanced Materials, 2009, 21, 463). Patterned surfaces having round-bottoms (e.g., a round-bottomed brick array) can be obtained by a combination of the Bosch reactive ion etching method and the isotropic reactive etching technique described in Plasma Etching: Fundamentals and Applications, M. Sugawara, et. al., Oxford University Press, (1998), ISBN-10: 019856287X.

Polymer films with patterned surfaces can be fabricated by means known in the art (e.g., roll-to-roll imprinting or embossing).

A patterned surface thus formed, if not fabricated from an innately hydrophobic material, can be coated with a hydrophobic material, such as low-surface-energy fluoropolymers (e.g., polytetrafluoroethylene), and fluorosilanes (e.g., heptadecylfluoro-1,1,2,2-tetra-hydrodecyl-trichlorosilane). Surface coating can be achieved by methods well known in the art, including plasma assisted chemical vapor deposition, solution deposition, and vapor deposition.

Note that the patterned surface can either be an integral part of the substrate or a separate layer on the substrate. For example, a patterned surface can be fabricated from a material (e.g., a silicon wafer or a polymer film) and used to cover another material (e.g., an aluminum plate). This can be useful when it is easier to fabricate a patterned surface from a material other than that of the substrate. Also, to obtain a large patterned surface on a large substrate, it is often necessary to fabricate smaller patterned surfaces and then place them on the large substrate.

To cover a substrate with a patterned surface, one can use standard methods (e.g., tiling, embossing, and rolling with a patterned roller, etc), as described in Whitesides et al., Chem. Review, 2005, 105, 1171-1196.

To analyze the topology of a patterned surface, one can use well-known methods, such as scanning electron microscopy (SEM) and atomic force microscopy (AFM). As mentioned above, a water droplet on a hydrophobic surface for use in this invention displays a contact angle of more than 90°, preferably more than 140°. The actual contact angle can be determined by methods well known in the art (e.g., with a contact angle goniometer).

Example 1 below provides detailed procedures of fabricating and analyzing different hydrophobic surfaces for use in the method of this invention.

To practice the method of this invention, a substrate having a patterned hydrophobic surface, preferably a patterned superhydrophobic surface, is subjected to ice formation conditions. For example, at standard atmospheric pressure, the substrate is subjected to a temperature below 0° C. (e.g., −10° C. to −25° C.) in the presence of static water droplets or impinging supercooled droplets.

In one embodiment, one can further confirm that the surface is substantially free of ice under impinging water droplets. To assess the presence or absence of ice on the substrate, one can use standard methods (e.g., visual inspection).

In another embodiment, if ice is formed on the substrate in the presence of static water droplets or upon impact of dynamic water droplets, the substrate can also be subjected to an ice removal treatment, i.e., any thermal, chemical, or physical method that leads to ice removal. For example, the substrate can be heated with a heating device, such as a heating coil included in the substrate. Importantly, due to reduced contact area and reduced adhesion, this process requires substantially lower energy inputs for ice removal compared to the energy inputs required for the removal of ice from any hydrophilic or unpatterned hydrophobic surfaces.

To study a patterned hydrophobic surface for use in the method of this invention, tests can be performed under conditions allowing ice formation. For example, the formation rate and morphology of ice nuclei of a static water droplet on a patterned hydrophobic surface can be determined using optical microscopes, horizontally-mounted cameras, and a water-cooled thermoelectric cooling stage, and compared to other surface types (e.g., an unpatterned surface). Ice accumulation on a patterned hydrophobic surface can also be evaluated in a wind tunnel or in dynamic drop tests using a capillary tube in contact with a thermoelectric cooler mounted above a water-cooled thermoelectric cooling stage with a substrate in a closed desiccator chamber, and high speed cameras, and compared to other surface types (e.g., a flat surface). In such tests, water droplets at a given temperature (e.g., −5° C.) are vertically dropped from a given height (e.g., about 10 cm) onto a substrate at a given temperature (e.g., a temperature between room temperature and −30° C.) and at a given angle to the horizontal (e.g., 30°). The force necessary to remove a droplet frozen on a substrate, i.e., the ease of ice removal, can also be quantified. For example, it can be quantified by assessing the maximum displacement upon fracture of a spring embedded in a droplet frozen on a substrate. Another example of ice removal involves assessing the thermal input required to allow a droplet frozen upon impact to slide off a tilted surface. Finally, mathematical models can be used to predict the contact area of an impinging droplet upon spreading, the contact time of a spreading droplet, and the pressure stability of a particular type of patterned surface.

Examples 2-5 provide detailed procedures of testing water droplets on certain patterned hydrophobic surfaces.

Also within the scope of this invention are (1) a substrate having a patterned (e.g., periodically patterned) hydrophobic surface including raised structures of a thickness of 0.01 μm to 1000 μm and a height of 0.1 μm to 1000 μm that form compartments having a surface free of angles that are less than or equal to 90° (e.g., round-bottomed compartments) of a length of 0.02 μm to 1000 μm and a width of 0.02 μm to 1000 μm; and (2) a substrate having a patterned (e.g., periodically patterned) hydrophobic surface including raised structures of a thickness of 0.01 μm to 1000 μm and a height of 0.1 μm to 1000 μm that form grooves having a surface free of angles that are less than or equal to 90° (e.g., round-bottomed grooves), in which the distance between two adjacent raised structures is 0.02 μm to 1000 μm.

To fabricate these two substrates and test them under ice formation conditions, one can use methods similar to those described above.

Without further elaboration, it is believed that the above description has adequately enabled the present invention. The following examples are, therefore, to be construed as merely illustrative, and not limitative of the remainder of the disclosure in any way whatsoever. All of the publications cited herein are hereby incorporated by reference in their entirety.

### EXAMPLE 1

### Fabrication of Patterned Hydrophobic Surfaces

Photolithography following the Bosch process was used to fabricate from 100 mm silicon wafers numerous surfaces of different patterns, including a cylindrical post array, a honeycomb array, a brick array, a box array, and a blade array. The table below lists different fabricated patterned surfaces with the given dimensions. It also lists water contact angles for certain surfaces coated with a fluorinated compound, as described below.

| | | Diameter/ | | | |
|---|---|---|---|---|---|
| | | wall thick- | Pitch/size | Depth | Contact Angle |
| Type | Name | ness (μm) | (μm) | (μm) | (°) |
| Post | | 1.5 | 3.6 | 8 | |
| Post | | 1.5 | 8 | 8 | |
| Post | | 2.0 | 10 | 10 | |
| Post | | 1.8 | 12 | 7 | |
| Post | | 1.5 | 16 | 9 | |
| Post | Post2-F | 0.3 | 2 | 10 | 171 |
| Post | Post5-F | 1.5 | 3.5 | 10 | 162 |
| Honeycomb | | 3.5 | 40 | 15 | |
| Brick | Brick40-F | 1.3 | 16 × 40 | 18 | 149 |
| Box | | 1.4 | 100 × 200 | 10 | |
| Box | | 1.4 | 100 × 800 | 10 | |
| Box | | 1.4 | 200 × 400 | 10 | |
| Blade | | 1 | 5 | 10 | |

The patterns were created by contact printing using 0.5 μm thick S1805 positive photoresist. Separate contact masks were fabricated to print a 60×60 or 40×40 mm square on silicon wafers. The patterns were then etched into the silicon wafers using the Bosch process, which uses two separate steps to create vertical sidewalls. Thus, SF₆ was first used to etch the Si, and then C₄F₈ was used to deposit a protective layer of fluoropolymer to prevent further Si etching. Vertical sidewalls were formed with certain undercuts and ripples relative to the mask. The photoresist was then stripped using oxygen plasma, and the wafers were cleaned with H₂SO₄/H₂O₂ Piranha wet etch.

For surfaces with submicron structures, projection lithography was used instead of contact lithography.

An epoxy (i.e., non-silicon) patterned substrate was also fabricated by replication of the silicon masters following the soft lithographic method described in Pokroy et al., Advanced Materials, 2009, 21, 463. The patterned epoxy replica had a brick array (wall thickness: 1.3 μm; depth: 18 μm; width: 16 μm; and length: 40 μm).

To form a hydrophobic surface, each patterned surface was coated with a thin layer (approximately 2 nm) of a fluorinated compound (e.g., heptadecylfluoro-1,1,2,2-tetra-hydrodecyl-trichlorosilane) using plasma assisted chemical vapor deposition. More specifically, the fluorinated compound was deposited from vapor on the surface in a vacuum chamber at 25° C. for 10 h.

All fabricated patterned surfaces were analyzed by SEM and the contact angle of a water droplet on certain patterned surface was determined by a standard goniometer with a high resolution camera designed for the measurements of contact angles.

SEM photomicrographs of silicon posts, honeycombs, and bricks similar to those used for the method of this invention and further details on the preparation of patterned hydrophobic surfaces can be found in Krupenkin et al., Langmuir, 2004, 20, 3824-3827, Henoch et al., AIAA Paper, 2006-3192. San Francisco, Calif., June 2006, and Ahuja et al., Langmuir, 2008, 24, 9-14.

Ice formation, accumulation, and adhesion were tested on a number of the substrates fabricated in this example. See Examples 2-4 below.

### EXAMPLE 2

### Investigation of Ice Formation Rates

Tests were performed to qualitatively measure the freezing rates of static water droplets on Post2-F under wetting and non-wetting conditions. For comparison, the test was also performed on a flat surface coated with a hydrophobic layer (contact angle: 114°).

These tests were performed using optical microscopes, horizontally-mounted cameras, and a water-cooled thermoelectric cooling stage to observe freezing in situ for water droplets under static conditions. The microscope cooling stage used was capable of cooling samples up to −40° C. within a closed chamber having a fog-free top window. A low-magnification stereo optical microscope (Leica MZ12) and an upright optical microscope (Leica DMRX) were used to observe the droplet freezing from a top view, and a contact angle system (KSV CAM101) was used to image from a side view. High-speed video cameras (Phantom V5, V7, and V9) and a high-resolution color CCD camera (QImaging) were also used for imaging.

In these tests, three droplets of water, distilled and deionized (DI) were first placed on the Si substrate; two on the patterned surface, and one on the flat surface. On the patterned surface, one droplet was in the Cassie-Baxter state (i.e., non-wetting state), while the other was forced to wet the pillars (Wenzel state) using electrowetting. The stage was then progressively cooled. It was observed that the wetting droplet on the patterned surface was the first to freeze, followed by the droplet on the flat surface, and finally by the non-wetting droplet on the patterned surface. Non-wettings droplets were always found to freeze last.

An important observation from these static freezing tests was that the droplet remained in the Cassie-Baxter state (i.e., non-wetting state) during freezing and melting on the patterned superhydrophobic surface, and therefore its contact area and adhesion strength was significantly reduced compared to the wetting droplet.

### EXAMPLE 3

### Investigation of Ice Accumulation

Dynamic drop tests were conducted on Brick40-F and Post5-F, two patterned silicon substrates with a hydrophobic fluorinated coating fabricated in Example 1.

One or more of the following five control surfaces were used in these tests: (i) the same brick surface without coating but treated in oxygen plasma for 20 min, i.e., having a hydrophilic surface (Brick40-C); (ii) a flat, fluorinated, hydrophobic Si wafer (Si—F) having a contact angle of 114°; (iii) a flat, hydrophilic Si (Si—C); (iv) a rough (i.e., unpolished) back side of a Si wafer with a hydrophobic fluorinated coating (Si-rough-F); and (v) a rough (i.e., unpolished) back side of a Si wafer having a hydrophilic surface (Si-rough-C). Si—F and Si-rough-F were obtained by depositing heptadecylfluoro-1,1,2,2-tetra-hydrodecyltrichlorosilane (Gelest) on a flat silicon wafer and a rough back side of a silicon wafer, respectively, in a vacuum chamber (25° C., 10 h). Si—C and Si-rough-C were obtained by treating the surface of a flat silicon wafer and a rough back side of a silicon wafer, respectively, in oxygen plasma for 20 min.

In these tests, water droplets at room temperature (RT) or super-cooled droplets at −5° C. were dropped on the substrate at controlled substrate temperatures (at RT, 0, −5, −10, −15, −20, −25, −30° C.) and at fixed tilt angles of 30° and 60° (relative to a horizontal direction). The experimental setup involved a capillary tube in contact with a thermoelectric cooler and a controller mounted on top of a closed desiccator chamber. Water droplets were dropped via the capillary into the chamber and onto the tested substrate positioned at a controlled distance below. The substrate was mounted onto a thermoelectric cooling stage on an angled micromanipulator stage, controlled remotely outside the chamber. An air flow was used to prevent condensation on the substrate and a syringe pump was used to control the water flow. To capture the motion and ice residue of the droplets upon impact, a long working distance macro lens, an aperture-controlling lens adapter ring, and a high-resolution color CCD or high-speed video camera were used.

In these dynamic tests, the temperature of the water droplet was RT or −5° C.; the temperature of the tested substrate was RT, 0° C., −10° C., −15° C., −20° C., or −25° C., the tilt angle of the substrate was 30° or 60°; and the drop height was 10.5 cm.

In one set of tests, Brick-40-F, tested at all of the temperatures listed above at a tilt angle of 30° with RT water droplets, was compared to Brick40-C, Si—F, Si—C, Si-rough-F, and Si-rough-C. It was found that the droplets bounced away from the surface for Brick40-F up to a substrate temperature of −20° C., while they wetted and consequently froze on all control surfaces. Under the tested conditions, the transition from bouncing-off to pinning (i.e., wetting and then freezing) occurred between −20° C. and −25° C.

In another set of tests, Brick40-F and Post5-F were tested under the same conditions, except that both substrates were at a tilt angle of 60° and were compared to Si—F. It was found that droplets bounced off the substrate surface for these two hydrophobic surfaces, while they slid substantially, but remained in contact and therefore eventually froze on Si—F.

In a third set of tests, Brick-40F was tested at the temperatures listed above and at a tilt angle of 30° with water droplets cooled to −5° C., with Brick40-C, Si—F, Si—C, Si-rough-F, and Si-rough-C as the controls. It was found that the droplets remained in a non-wetting state at temperatures up to −20° C. on Brick40-F. The transition to pinning occurred around −20° C. and the droplet was pinned and frozen on this substrate at −20° C. The supercooled droplets wetted all control surfaces and froze in place.

In a further set of tests, Brick40-F and Post5-F at substrate temperatures of 0° C., −15° C., and −25° C. and a tilt angle of 60° were tested with water droplets at −5° C., with Si—F as the control. It was found that the transition from non-wetting to pinning and freezing occurred later at a tilt angle of 60° than at a tilt angle of 30°. While Si—F began to wet and accumulate ice at −15° C., Brick40-F did not accumulate ice until −25° C. and Post5-F was not wet even at −30° C.

Similar results were obtained for a Brick40-F epoxy replica coated with a silane and fabricated as described in Example 1.

To determine the effect of substrate anisotropy, similar tests (drop height: 10 cm; substrate tilt angle: 30°; droplet temperature: −5° C.) were performed on both Brick40-F, duplicate, and a hydrophobic substrate having a blade array (wall thickness: 1 μm; depth: 10 μm; spacing: 5 μm), also duplicate. The orientation of the bricks and the blades on the surfaces was either horizontal or vertical and the substrates were progressively cooled to −25° C. It was found in these tests that the retraction of the droplet was anisotropic for the substrates having blades as a function of the orientation of the blades. For the two substrates having a brick array, no retraction anisotropy was observed but a collapse anisotropy was observed at −25° C. (i.e., the transition temperature). This collapse anisotropy was also a function of the orientation of the bricks.

In yet another set of tests, ice accumulation was studied on both Brick-40F and Post5-F, fabricated in Example 1. Brick-40F was assayed at a temperature of −10° C. and a tilt angle of 30° with supercooled water droplets at a temperature of −2° C. dropped with a flow rate of 0.30 mL/min, with Si—F and Si-rough-F as the controls. Ice began to accumulate almost immediately on all the control surfaces, while no ice was formed on the superhydrophobic surface of Brick-40F. Post5-F was assayed at a temperature of −15° C. and at a tilt angle of 30°, with Si—F and a rough hydrophilic aluminum substrate as the controls. The temperature of the water droplets was 0° C. and the flow rate was 0.3 mL/min. It was shown that no ice was formed on the patterned superhydrophobic surface even after 10 minutes, while ice was formed on the control surfaces.

### EXAMPLE 4

### Investigation of Ice Adhesion

Ice adhesion onto Brick40-F, fabricated as described in Example 1, was determined qualitatively for ice droplets frozen on the surface. In this test, frozen wetting and non-wetting droplets were pulled from the surface using a section of Cu wire embedded within each droplet. The fracture of the wetting droplet and the removal of the non-wetting droplet from the surface were recorded with a high-speed camera. The ease of removal of the whole intact non-wetting droplet from the superhydrophobic surface was compared to the incomplete, fractured removal of a wetting droplet.

Ice adhesion onto Post5-F, fabricated as described in Example 1, was also studied. The results were compared to those obtained for a flat hydrophobic surface (contact angle: 90°). A spring was placed into the droplet before it froze on each surface. In this test, the maximum displacement of the spring during removal was proportional to the force required to remove the droplet. A larger displacement, i.e., a larger force, was observed for a droplet on a hydrophobic surface than for a non-wetting droplet on a superhydrophobic surface due to the relative strength of the ice-surface interface in the former case. It was found that the force necessary to remove a 100-μL water droplet was at least 2.4 times smaller for the patterned superhydrophobic surface than that for the flat surface. It was observed that even after removal of the ice from the flat surface, multiple ice pieces remained attached, while the entire ice sphere was cleanly removed from the patterned superhydrophobic surface.

### EXAMPLE 5

### Investigation of Shedding from Tilted Surfaces

A group of droplets (T_{droplet}=20° C.) was impinged from a 10 cm height simultaneously onto three surfaces (T_{substrate}=−30° C.; hydrophilic Al, fluorinated hydrophobic Si, and microstructured fluorinated Si) tilted at 15°, freezing immediately upon contact. With a small thermal energy input, as the substrate temperature was raised above 0° C., layers of ice which formed on the patterned superhydrophobic region easily slid off. Droplets on the unpatterned hydrophobic region and the hydrophilic region remained pinned and did not slide off even upon fully melting. Thus, we observed under our experimental conditions that, even upon impact and immediate freezing, the droplets that freeze on the superhydrophobic surface remain in a non-wetting Cassie state (where the ice rests only on the tips of the structure) similar to static droplet freezing, making ice buildup much more tractable than the stubborn sheets formed on flat surfaces.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. For example, patterned hydrophobic substrates analogous to those described above can also be fabricated, tested, and used to practice this invention. Thus, other embodiments are also within the claims.

What is claimed is:

1. A method comprising subjecting to conditions allowing ice formation a substrate having a patterned hydrophobic surface, wherein the hydrophobic surface has raised structures, the height of each raised structure being 0.1 μm to 1000 μm, the thickness of each raised structure being 0.01 μm to 1000 μm, and the distance between two adjacent raised structures being 0.02 μm to 1000 μm.

2. The method of claim 1, wherein the height of each raised structure is 1 μm to 50 μm, the thickness of each raised structure is 0.1 μm to 50 μm, and the distance between two adjacent raised structures is 0.5 μm to 100 μm.

3. The method of claim 1, wherein the height of each raised structure is 2 μm to 10 μm, the thickness of each raised structure is 0.5 μm to 10 μm, and the distance between two adjacent raised structures is 1 μm to 50 μm.

4. The method of claim 1, wherein the raised structures form a periodic pattern.

5. The method of claim 4, further comprising, after the subjecting step, confirming that the hydrophobic surface is substantially free of ice.

6. The method of claim 4, further comprising subjecting the substrate to an ice removal treatment.

7. The method of claim 4, wherein the height of each raised structure is 1 μm to 50 μm, the thickness of each raised structure is 0.1 μm to 50 μm, and the distance between two adjacent raised structures is 0.5 μm to 100 μm.

8. The method of claim 4, wherein the raised structures form compartments.

9. The method of claim 4, wherein the compartments are arranged in rows.

10. The method of claim 9, wherein the compartments have a surface free of angles that are less than or equal to 90°.

11. The method of claim 10, wherein the height of each raised structure is 0.1 μm to 1000 μm, the thickness of each raised structure is 0.01 μm to 1000 μm, and each compartment has a width between 0.02 μm and 1000 μm and a length between 0.02 μm and 1000 μm.

12. The method of claim 11, wherein the height of each raised structure is 1 μm to 100 μm, the thickness of each raised structure is 0.1 μm to 50 μm, and each compartment has a width between 0.25 μm and 200 μm and a length between 0.25 μm and 200 μm.

13. The method of claim 12, wherein the height of each raised structure is 2 μm to 20 μm, the thickness of each raised structure is 0.5 μm to 10 μm, and each compartment has a width between 1 μm and 50 μm and a length between 1 μm and 50 μm.

14. The method of claim 9, wherein a first row of the compartments, extending along a first direction, and a second row of the compartments, adjacent to the first row and extending along the first direction, are staggered relative to each other along the first direction.

15. The method of claim 14, wherein the compartments have a surface free of angles that are less than or equal to 90°.

16. The method of claim 8, wherein the height of each raised structure is 0.1 μm to 1000 μm, the thickness of each raised structure is 0.01 μm to 1000 μm, and each compartment has a width between 0.02 μm and 1000 μm and a length between 0.02 μm and 1000 μm.

17. The method of claim 16, wherein the height of each raised structure is 1 μm to 100 μm, the thickness of each raised structure is 0.1 μm to 50 μm, and each compartment has a width between 0.25 μm and 200 μm and a length between 0.25 μm and 200 μm.

18. The method of claim 17, wherein the height of each raised structure is 2 μm to 20 μm, the thickness of each raised structure is 0.5 μm to 10 μm, and each compartment has a width between 1 μm and 50 μm and a length between 1 μm and 50 μm.

19. The method of claim 8, wherein the compartments have a surface free of angles that are less than or equal to 90°.

20. The method of claim 4, wherein the raised structures are posts.

21. The method of claim 20, wherein the posts have a diameter between 0.01 μm and 100 μm, a height between 0.1 μm and 1000 μm, and a pitch between 0.05 μm and 200 μm

22. The method of claim 21, wherein the posts have a diameter between 0.05 μm and 25 μm, a height between 1 μm and 100 μm, and a pitch between 0.1 μm and 50 μm.

23. The method of claim 22, wherein the posts have a diameter between 0.2 μm and 5 μm, a height between 5 μm and 25 μm, and a pitch between 0.5 μm and 10 μm.

24. The method of claim 4, wherein the raised structures form grooves.

25. The method of claim 24, wherein the thickness of each raised structure is 0.1 μm to 50 μm, the height of each raised structure is 1 μm to 100 μm, and the distance between two adjacent raised structures is 0.25 μm to 100 μm.

26. The method of claim 25, wherein the thickness of each raised structure is 0.5 μm to 10 μm, the height of each raised structure is 2 μm to 20 μm, and the distance between two adjacent raised structures is 1 μm to 25 μm.

27. The method of claim 24, wherein the grooves are sinuous.

28. The method of claim 24, wherein the grooves have a surface free of angles that are less than or equal to 90°.

29. A substrate having a hydrophobic surface, wherein the hydrophobic surface has raised structures, each having a height between 0.1 μm and 1000 μm and a thickness between 0.01 μm and 1000 μm, that form compartments, wherein each compartment has a width between 0.02 μm and 1000 μm, a length between 0.02 μm and 1000 μm, and a surface free of angles that are less than or equal to 90°.

30. The substrate of claim 29, wherein the compartments are round-bottomed.

31. The substrate of claim 30, wherein the height of each raised structure is 1 μm to 100 μm, the thickness of each raised structure is 0.1 μm to 50 μm, and each compartment has a width between 0.25 μm and 200 μm and a length between 0.25 μm and 200 μm.

32. The substrate of claim 31, wherein the height of each raised structure is 2 μm and 20 μm, the thickness of each raised structure is 0.5 μm to 10 μm, and each compartment has a width between 1 μm and 50 μm and a length between 1 μm and 50 μm.

33. The substrate of claim 32, wherein the compartments are arranged in rows.

34. The substrate of claim 33, wherein a first row of the compartments, extending along a first direction, and a second row of the compartments, adjacent to the first row and extending along the first direction, are staggered relative to each other along the first direction.

35. A substrate having a hydrophobic surface, wherein the hydrophobic surface has raised structures, each having a thickness between 0.01 μm and 1000 μm and a height between 0.1 μm and 1000 μm, that form grooves, wherein the distance between two adjacent raised structures is 0.02 μm to 1000 μm and the surface of the grooves is free of angles that are less than or equal to 90°.

36. The substrate of claim 35, wherein the grooves are round-bottomed.

37. The substrate of claim 36, wherein the thickness of each raised structure is 0.1 μm to 50 μm, the height of each raised structure is 1 μm to 100 μm, and the distance between two adjacent raised structures is 0.25 μm to 100 μm.

38. The substrate of claim 37, wherein the thickness of each raised structure is 0.5 μm to 10 μm, the height of each raised structure is 2 μm to 20 μm, and the distance between two adjacent raised structures is 1 μm to 25 μm.
